(19) United States
(12) Patent Application Publication
(10) Pub. No.: US 2008/0019813 A1
(43) Pub. Date: Jan. 24, 2008

(54) EZ load/unload

(76) Inventor: Elmer Leon Lavely, Richwoods, MO (US)

Correspondence Address: E. LEON LAVELY, SR., PO BOX 61, RICHWOODS, MO, 63071, US

(21) Appl. No.: 11/431,193

(22) Filed: Jul. 20, 2006

(51) Int. Cl. B60P 1/04

(52) U.S. Cl. 414/468

(57) ABSTRACT

The “EZ Load/Unload” contains two components that can be used individually or in combination. These components are to be used to reduce the wear and tear on tow trucks, tow-beds and cars being towed. See drawings for examples.

The components for the “EZ Load/Unload” include the addition of a rear winch and set of J-hooks, used to remove the towed vehicle from the tow-bed.

The second component is a double set of rollers to be embedded into slots in both sides of the tow-bed. These rollers will be fit into slots and will allow wheels or tires to easily slide on or off the tow-bed.

The “EZ Load/Unload” will work with existing tow beds and in manufacturing of new beds. Existing beds can utilize only the rear winch or can be modified to include the rollers.

The concept behind this utility patent is to reduce costs and provide an easier way to load and unload all vehicles on tow trucks. The main focus is directed toward disabled, wrecked, and illegally parked or locked vehicles, but works for all tow beds, all vehicles.

The improvements in this patent are designed to reduce the wear and tear on the tow-truck, tow-bed and the vehicle being towed. An additional benefit will be a reduced cost of truck maintenance and less damage to the vehicle in tow, which will reduce owner/operator payouts.

I hereby declare the following to be a full, clear an exact description of this invention, such as will enable others skilled in the art to which it pertains to make and use the same.

My invention relates to the improvements of a tow truck bed; as to loading and unloading automobiles. In the accompanying drawing, FIG. 1, will provide a top down view of an existing tow truck bed and cab, the original winch that comes with the tow-truck (D), with the inclusion of two sets of fitted rollers (A), the additional rear winch (C), an additional set of J-Hooks (B1) and a cable guide (E). These components are used to load and unload vehicles onto the tow-bed. Note that any combination of these components can be used independently. A rear winch (C), a rear cable track (E) and J-Hooks (B1) can be purchased anywhere and be installed by together to use as a reverse un-loader. Just as the fitted rollers, (A), can be incorporated into a tow-bed without the any additional features.

Referring to the FIG. 1, (A) represents a line of stainless steel rollers that sit in slots cut into the tow bed. Each roller will be 08-12 total inches in length, 2-4 inches in circumference. Each roller will be spaced between 6 to 8 inches apart, starting 3 to 4 feet from the front of the bed and stopping 3 to 4 feet from the end of the tow-bed. The rollers do not need to be the full length of the bed, as the tires roll onto the solid surface of the truck bed, the surface will prevent the car from moving backward or forward around on the bed during travel.

Each roller (A1), has a rod running through it that extends past the roller by 1 to 2 inches, and is represented by (A1) in FIG. 1 drawing. A1 can be designed as individual rollers cut into an existing bed, sitting in slots, or as a strip of rollers that can be manufactured and built into the bed. This line of rollers is on both sides of the tow-bed, as identified in FIG. 1, (A).

Referring to FIG. 1, B is the original J-hooks that work in conjunction with the add-on winch (C) and cable guide (E). B and C work in unison to pull an automobile off the tow-bed, from the rear. E will keep the cable in one place and help guide the removal of the vehicle in a straight line. To do this, the front wench is put in neutral and the rear winch, B, is engaged, which will pull the rear, reducing the wear and tear on the tow-truck. The combination of J-Hooks and Winches (B, C and B1 and D), can be the same size/strength of the front winch and hooks, but the rear winch can be smaller, as gravity will help with the unloading process.

As the vehicle is loaded, the rear J-hooks (B1) will attach to the frame (front or back) of the vehicle; and with the rear winch (C) in neutral, the front winch (D), will pull the vehicle into place. The rear winch (C) will also help hold the towed vehicle in place during transporting, after the rear winch (C) is locked into place and put in gear.

The unload process is accomplished with the front winch, D in neutral; the rear winch will pull the vehicle backwards; a reverse action from the load. After the vehicle is moved to the off the bed, the truck can move forward to complete the vehicle unload.

Most drivers unload the truck by applying some type of lubricant (grease, oil) and with the truck bed in the tilted position, jerking the truck forward and backward, which puts strain on the truck, hoses, valves and can damage the towed vehicle being towed as well as the tow-truck.

The additional cable track (E) at the base of the tow-bed will provide a surface for the cables to slide against/through. This allows for smooth operation of the rear winch (C) and faster removal of the vehicles. The levers for the rear winch (C) can be placed in the same area as the front winch for ease of operations.

### BRIEF DESCRIPTION OF THE DRAWING

FIG. 1—Complete view of existing tow truck cab tow bed, existing winch and J-Hooks, and all components of the EZ Load/Unload.

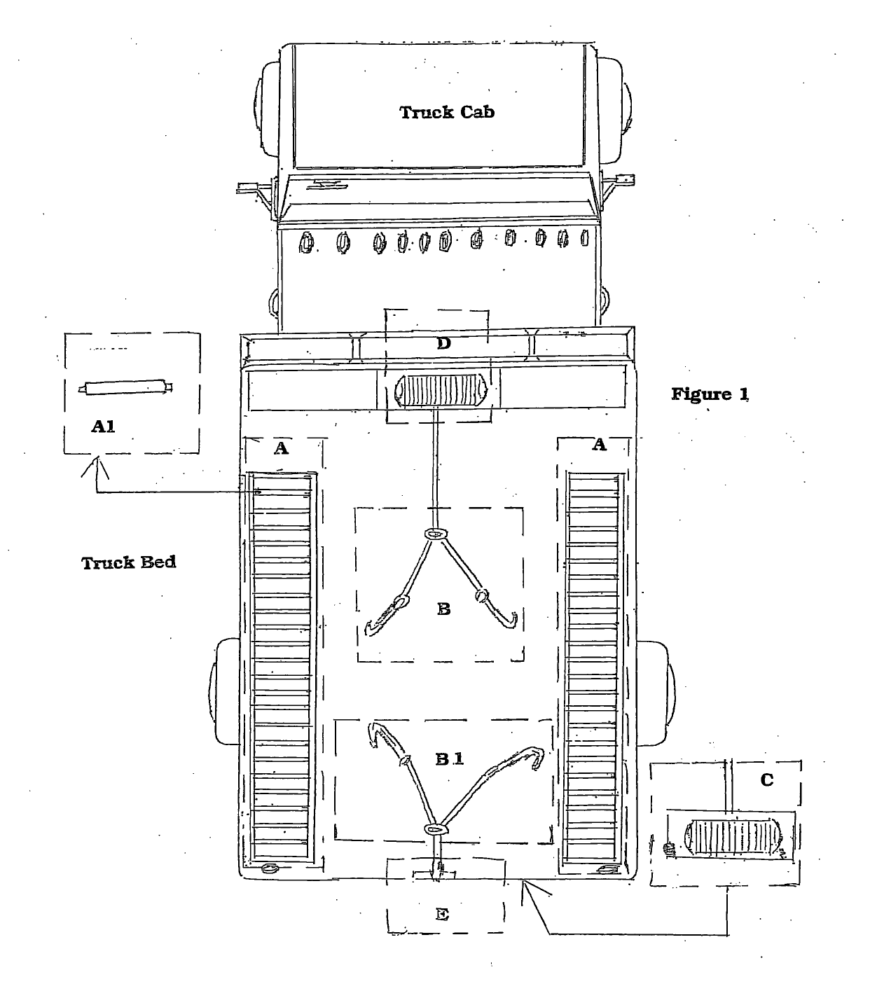

A—View of the two rows of 10-12 inch stainless steel rollers embedded into each side of the tow bed. Part of the EZ Load/Unload patent.

A1—View of individual roller that makes up A. Part of the EZ Load/Unload patent.

B—View of original J-Hooks attached to the front winch (D) to drag a vehicle onto the tow bed.—Original Equipment

B1—View of additional set of J-Hooks, attached to (C) and guided by the cable guide (E). Part of the EZ Load/Unload patent.

C—View of a Rear Winch—Additional winch installed underneath the bed to drag the vehicle off the tow bed. Part of the EZ Load/Unload patent.

D—View of the Front Winch—Original equipment.

E—View of a new Cable Guide—Installed roller to guide the rear winch cable from (B1 and C), as the vehicle is pulled backwards off the tow bed.

1. I, Leon Lavely, claim this utility patent named “EZ Load/Unload” to be my own thoughts and invention. The purpose of the EZ Load/Unload is to reduce wear and tear on tow beds and cars being towed.
“EZ Load/Unload” allows for modifications to existing tow beds and in the manufacturing of new beds. These modifications include an additional rear winch pull a car backward from the tow-bed and rollers on both sides of the bed, spaced evenly in the bed to allow the car to “slide” off instead of being drug.
